(19) United States
(12) Patent Application Publication
(10) Pub. No.: US 2015/0178281 A1
(43) Pub. Date: Jun. 25, 2015

(54) DETERMINING WHETHER A USER HAS SEEN A CONTENT ITEM

(71) Applicant: Google Inc., Mountain View, CA (US)

(72) Inventors: David Steiner, Boston, MA (US); Mehul Agarwal, Boston, MA (US); Imad Jureidini, Arlington, MA (US)

(73) Assignee: Google Inc., Mountain View, CA (US)

(21) Appl. No.: 14/136,304

(22) Filed: Dec. 20, 2013

(51) Int. Cl. G06F 17/30

(52) U.S. Cl. CPC G06F 17/3053

(57) ABSTRACT

Embodiments of the invention determine whether a user has seen a content item based on at least two factors: a measure of the area of a content item that has been displayed on a screen of the user's device and a length of time that the content item has been displayed on the screen of the user's device. The area of a content item that has been displayed is detected, and the length of time that the content item has been displayed is detected. An aggregate score for the content item is determined based at least in part on the detected area and the detected length of time. Responsive to the aggregate score exceeding a threshold, it is determined that the content item has been seen by the user.

### BACKGROUND

1. Field of Disclosure

This disclosure relates to the presentation of content items to a user on a computing device.

2. Description of the Related Art

Many people use their computing devices to consume content. For example, it is common for people to read email, articles, blogs, books, and other forms of content from their computing devices. Because of the extreme amounts of content that are available electronically, it is impossible for any person to consume it all. Thus, users tend to be selective in terms of the content items that they decide to read. Whereas a content aggregator may display hundreds or thousands of content items according to various organizational principles (e.g., alphabetically, categorized by subject, by timestamp, etc.), a user may navigate just to selected content items of interest. In the process, the user may bypass any number of other content items.

Traditionally, content providers and web analytics companies have tracked which content items have been accessed by a user, for example, by recording when a user clicks through on a link to a content item. Such systems rely on the user to affirmatively access the content item. If the user merely passively views information displayed about the content item without clicking through on it, such systems cannot distinguish these situations from ones where the user ignores the content item entirely.

### SUMMARY

Embodiments of the invention determine whether a user has seen a content item based on at least two factors: a measure of the area of a content item that has been displayed on a screen of the user's device and a length of time that the content item has been displayed on the screen of the user's device. The area of a content item that has been displayed is detected, and the length of time that the content item has been displayed is detected. An aggregate score for the content item is determined based at least in part on the detected area and the detected length of time. Responsive to the aggregate score exceeding a threshold, it is determined that the content item has been seen by the user.

Embodiments of the computer-readable storage medium store computer-executable instructions for performing the steps described above. Embodiments of the system further comprise a processor for executing the computer-executable instructions.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

FIG. 1 is a high-level block diagram illustrating an embodiment of an environment for presenting content items on a client device.

FIG. 2 is a high-level block diagram illustrating an example computer for implementing the entities shown in FIG. 1.

FIG. 3 is a block diagram illustrating an information presentation module according to one embodiment.

FIG. 4 is a block diagram illustrating an example of a scoring module according to one embodiment.

FIG. 5 is a flowchart illustrating a method of determining if a content item has been seen according to an embodiment.

FIG. 6A illustrates an example of a user interface displaying the majority of a first content card and a small portion of a second content card, according to an embodiment.

FIG. 6B illustrates an example of the user interface shown in FIG. 6A after a user has scrolled down to reveal a larger portion of the second content card, according to an embodiment.

The Figures (FIGS.) and the following description describe certain embodiments by way of illustration only. One skilled in the art will readily recognize from the following description that alternative embodiments of the structures and methods illustrated herein may be employed without departing from the principles described herein.

### DETAILED DESCRIPTION

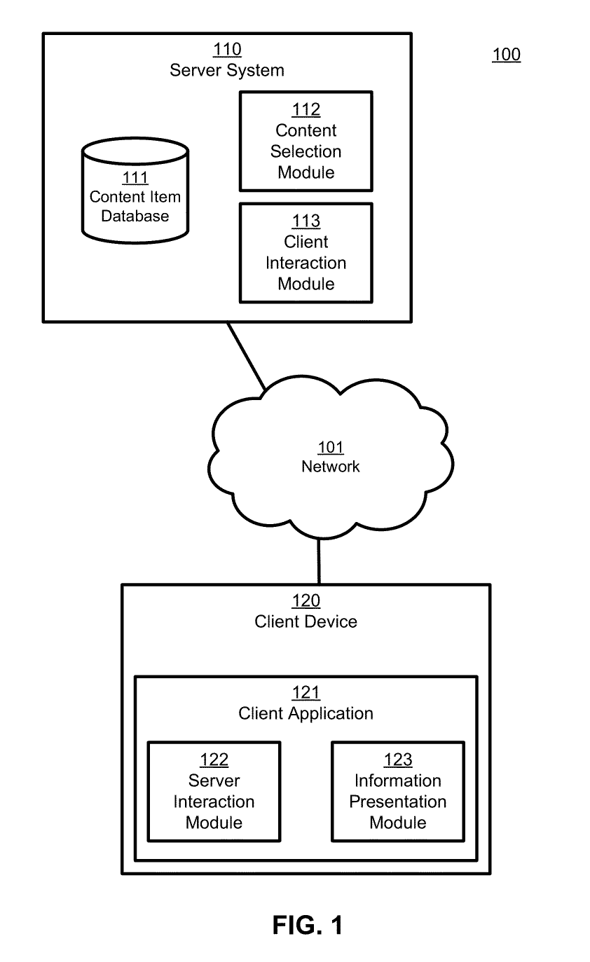

FIG. 1 is a high-level block diagram illustrating an embodiment of an environment 100 for presenting content items on a client device 120. The environment 100 includes a server system 110 and a client device 120 connected by a network 101. Only one server system 110 and one client device 120 are illustrated, but in practice there may be multiple instances of each of these entities. For example, there may be thousands or millions of client devices 120 in communication with several or many server systems 110.

The server system 110 selects and serves content items to the client device 120. In some embodiments, the server system 110 is implemented as a single server, while in other embodiments it is implemented as a distributed system of multiple servers. The server system 110 includes a content item database 111, a content selection module 112, and a client interaction module 113.

The content item database 111 of the server system 110 stores content items for distribution to client devices 120. The content items may be, for example, news articles, photographs, blog postings, status updates, advertisements, or any other type of content items that may displayed on a client device 120.

The content selection module 112 accesses items from the content item database 111 to serve to the client device 120. The content items may be chosen by the content selection module 112 in response to requests communicated from the client device 120 or the content items may be chosen in response to instructions from the server system 110 or other system (not shown) of the environment 100.

The client interaction module 113 manages the interactions of the server system 110 with the client device 120. Specifically, the client interaction module 113 communicates content items to the client device 120, and may receive reports from the client device 120 regarding which content items have been determined to be seen by the user of the client device 120, in accordance with embodiments of the invention.

The client device 120 is a computing device, such as a desktop, laptop, or tablet computer, or a smart phone or other mobile computing device. The client device 120 is used by a user to access content items through a client application 121 for example for information or entertainment purposes.

The client application 121 is a software application, for example running within the operating system of the client device 120. The software application contains program modules to implement the functionality described herein. Specifically, as illustrated in this example, the client application 121 includes a server interaction module 122 and an information presentation module 123.

The server interaction module 122 of the client application 121 manages the interactions of the client application 121 with the server system 110. The server interaction module 122 communicates data between the client device 120 and the server system 110 via the network 101. The server interaction module 122 sends request for content via the network 101 to the server system 110. Additionally, the server interaction module 122 may receive content items from the server system 110, either in response to requests from the client application 121 or in response to the server system 110 pushing content items to the client application 121 without them being specifically requested. The server interaction module 122 may request and receive content items and report usage of the application, including which displayed content items have been determined to be seen by the user of the client device, in accordance with embodiments of the invention.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the server system 110 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the server system 110.

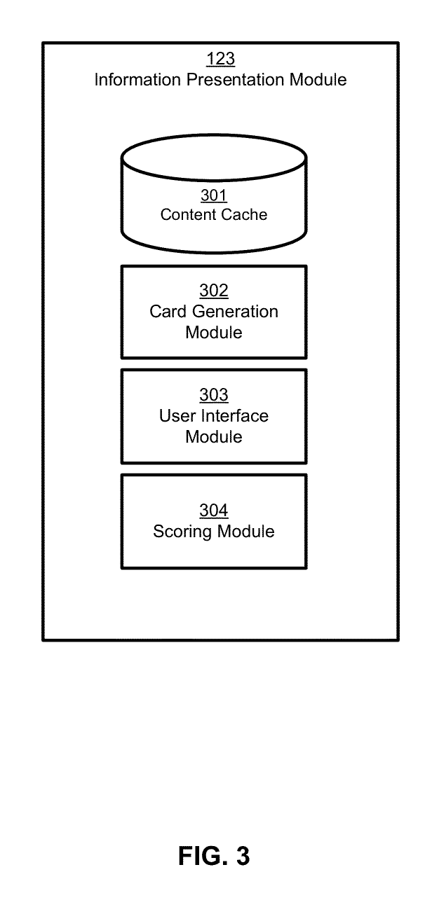

The information presentation module 123 formats the content items received from the server system 110 for presentation on the client device 120 to the user. The information presentation module 123 tracks the display of content items on the client device 120 and determines whether the content items have been seen by the user, based at least in part on a measure of the area of a content item that was displayed on a screen of the user's device and a length of time that the content item was displayed on the screen of the user's device. The information presentation module 123 will be described in greater detail below with reference to FIG. 3.

The network 101 provides a communication infrastructure between the server system 110 and the client device 120. The network 101 is typically the Internet, but may be any network, including but not limited to a Local Area Network (LAN), a Metropolitan Area Network (MAN), a Wide Area Network (WAN), a mobile wired or wireless network, a private network, or a virtual private network.

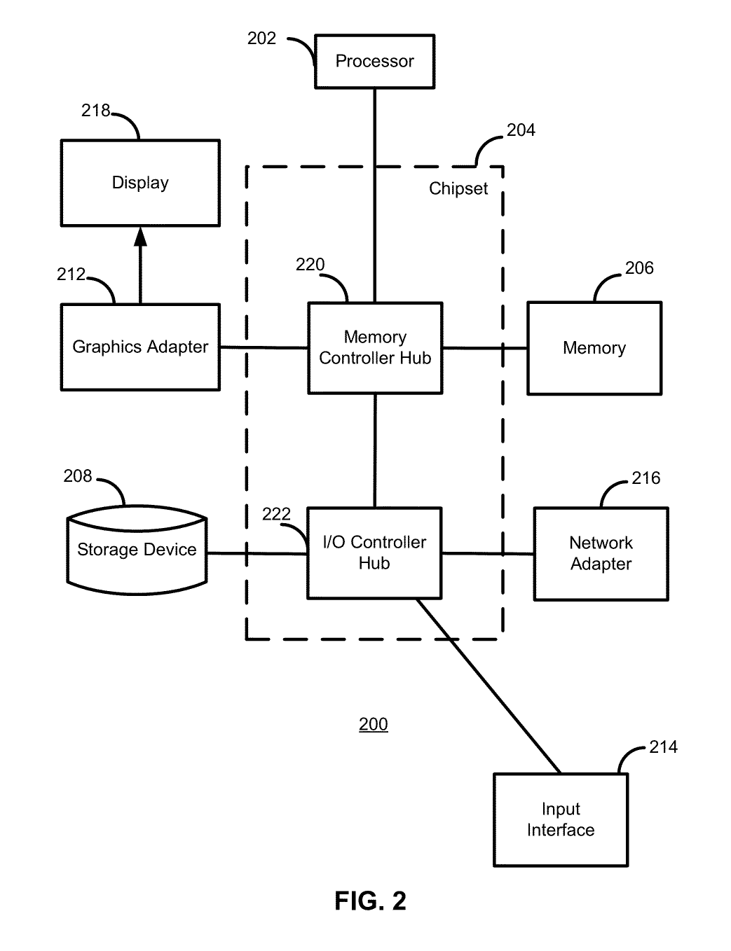

FIG. 2 is a high-level block diagram illustrating an example computer for implementing one or more of the entities shown in FIG. 1. The computer 200 includes at least one processor 202 coupled to a chipset 204. The chipset 204 includes a memory controller hub 220 and an input/output (I/O) controller hub 222. A memory 206 and a graphics adapter 212 are coupled to the memory controller hub 220, and a display 218 is coupled to the graphics adapter 212. A storage device 208, an input device 214, and network adapter 216 are coupled to the I/O controller hub 222. Other embodiments of the computer 200 have different architectures.

The storage device 208 is a non-transitory computer-readable storage medium such as a hard drive, compact disk read-only memory (CD-ROM), DVD, or a solid-state memory device. The memory 206 holds instructions and data used by the processor 202. The input interface 214 is a touch-screen interface, a mouse, track ball, or other type of pointing device, a keyboard, or some combination thereof, and is used to input data into the computer 200. In some embodiments, the computer 200 may be configured to receive input (e.g., commands) from the input interface 214 via gestures from the user. Gestures are movements made by the user while contacting a touch-screen interface. For example, tapping a portion of the screen, touching a portion of the screen and then dragging the touched portion in a particular direction, etc. The computers 200 monitors gestures made by the user and converts them into commands (e.g., dismiss, maximize, scroll, etc.) The graphics adapter 212 displays images and other information on the display 218. The network adapter 216 couples the computer 200 to one or more computer networks, such as network 101.

The computer 200 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 208, loaded into the memory 206, and executed by the processor 202.

The types of computer 200 used by the entities of FIG. 1 can vary depending upon the embodiment and the processing power required by the entity. For example, the server system 110 may include multiple computers 200 communicating with each other through a network to provide the functionality described herein. Such computers 200 may lack some of the components described above, such as graphics adapters 212 and displays 218.

FIG. 3 is a block diagram illustrating an information presentation module of the client application 121 according to one embodiment. The information presentation module includes a content cache 301, a card generation module 302, a user interface module 303, and a scoring module 304.

The content cache 301 stores content items received from the server system 110. Each content item in the content cache 301 may be stored with a corresponding indication of whether the user has seen the content item and optionally, whether the user has read the content item. The content cache 301 may store both content items that have been communicated from the server system 110 in preparation to be shown to the user as well as content items that have recently been presented to the user.

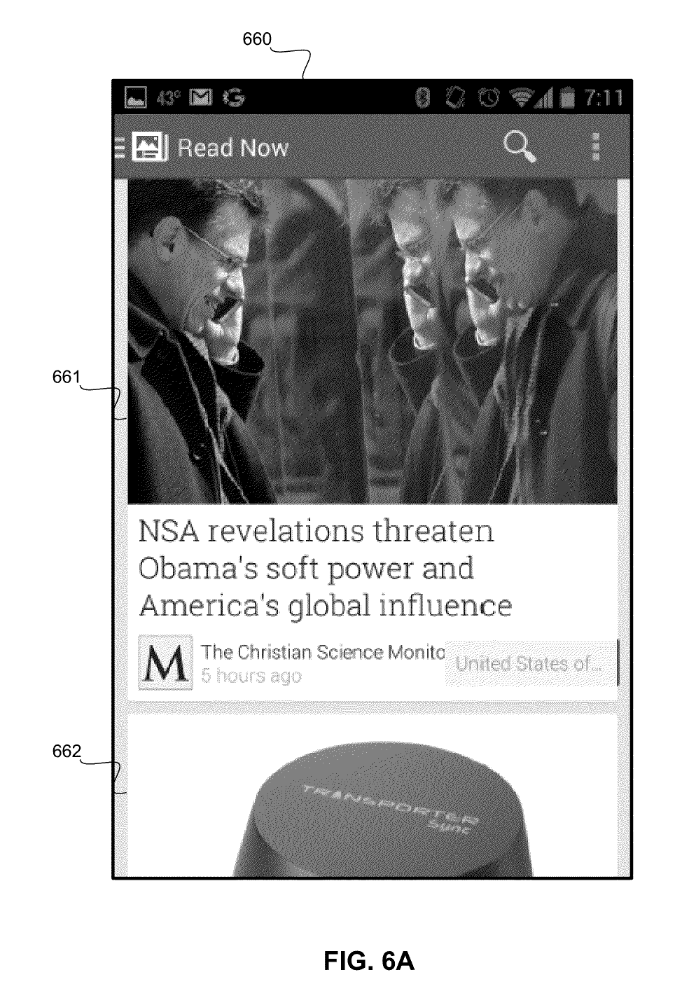

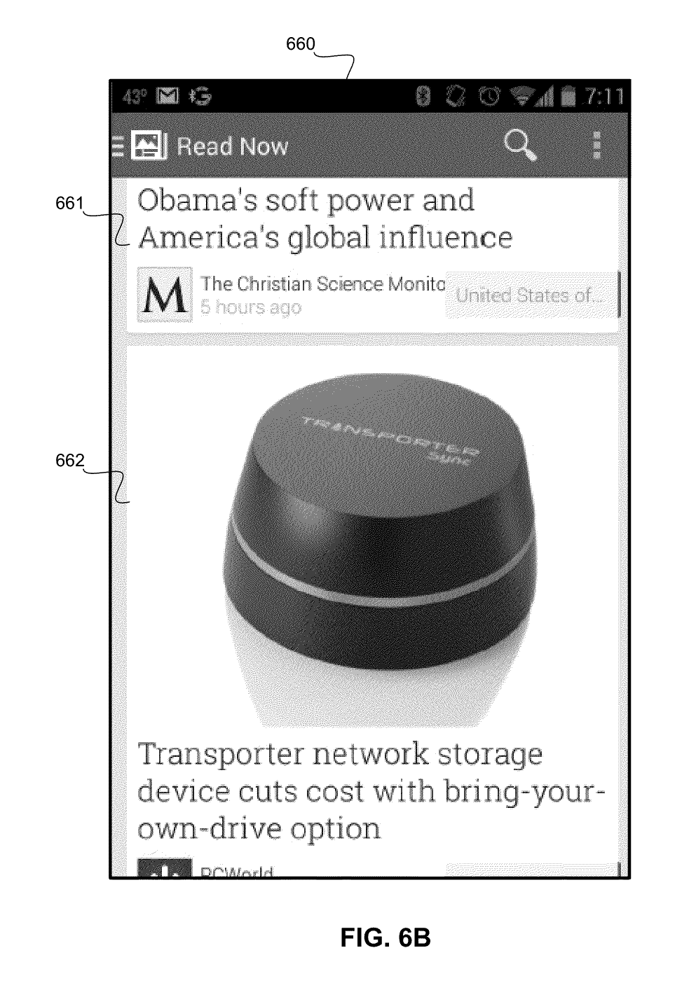

The card generation module 302 retrieves content items from the content cache 301 and, in one embodiment, formats each item as a separate card. A card is a two-dimensional layout of a content item's text and/or image data. The card contains information, such as textual or graphical information within its borders, as if the information were written on the card. The card has a width and a length, which may be sized appropriately for display on the screen of the respective client device 120. For example, the width of a card may be slightly less wide than the width of the screen of the client device 120, and the length of a card may be sized to display the entire card on the screen of the client device 120 without scrolling. Examples of cards are illustrated in FIGS. 6A and 6B, described below.

The user interface module 303 interprets the user's interaction with the input interface 214 of the client device 120 and makes corresponding changes to the display of the cards on the screen of the client device 120. For example, in response to a user's slow scrolling down gesture, the user interface module 303 may cause the next card to appear below the currently displayed card as the currently displayed card moves up on the screen of the client device 120. In response to a user's rapid scrolling gesture, the user interface module 303 may cause each of a sequence of cards to quickly move across the screen in a similar manner. The examples here and in FIGS. 6A-6B are described as being a vertical arrangement of cards where the lower edge of a first card is adjacent to the upper edge of a second card and so on. However, in other implementations, horizontal arrangements of cards are also possible, where the right edge of the first card is adjacent to the left edge of the second card and so on.

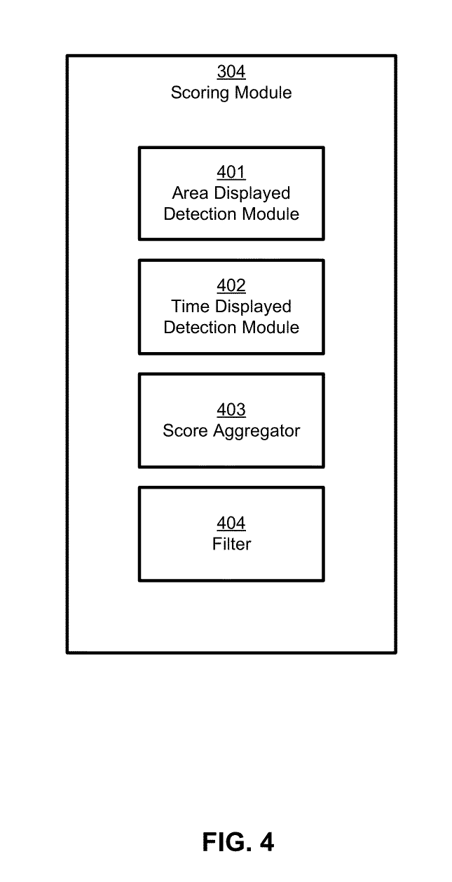

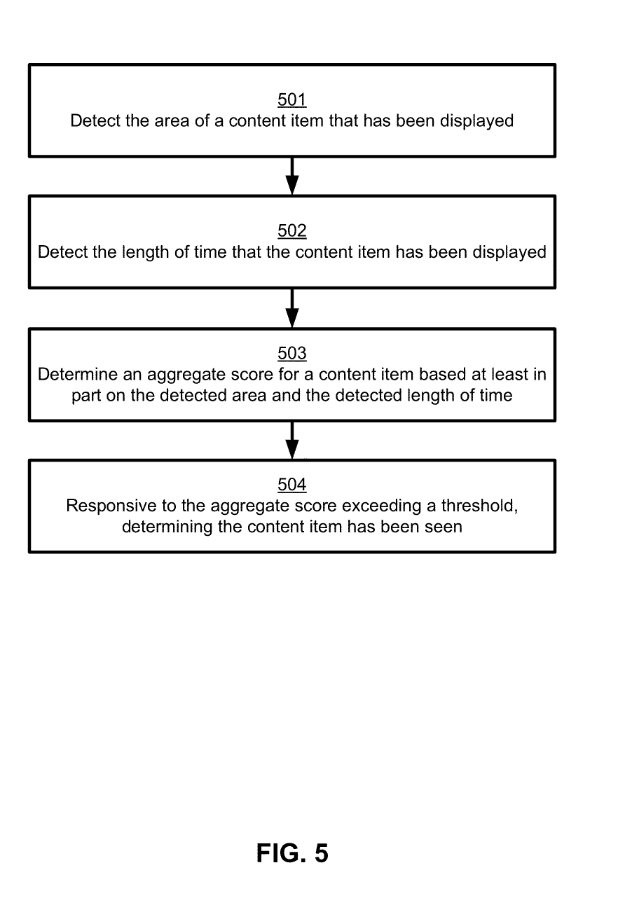

The scoring module 304 determines whether a content item has been seen by the user, based at least in part on a measure of the area of a content item (e.g., the portion of the content item's card) that was displayed on a screen of the user's device and a length of time that the content item was displayed on the screen of the user's device. The scoring module 304 and its operation will be described in greater detail below with respect to FIGS. 4-5.

FIG. 4 is a block diagram illustrating an example of a scoring module 304 according to one embodiment. In short, the scoring module 304 determines whether enough of the content item was displayed on the screen of the client device 120 for a long enough period of time that even if the user did not consciously read the content item, the user would nevertheless have gained a basic level of familiarity with the content item. The content items that the scoring module 304 determines that the user has seen are no long entirely new to the user. If the content item were to be displayed to the user again, the user is likely to know or suspect that they have seen the content item before. In order to determine whether the user has seen a content item, the scoring module 304 includes an area displayed detection module 401, a time displayed detection module 402, a score aggregator 403 and a filter 404.

The area displayed detection module 401 detects the amount of area of a content item that has been displayed to the user by the user interface module 303. Generally, the amount of area of the content item that has been displayed is indicative of whether the scoring module 304 should determine that the user has seen the content item. In one embodiment, as the amount of area of the content item that has been displayed increases, so does the likelihood that the user saw the content item. Various scoring schemes may be used, such as awarding points corresponding to the percentage of the area of the content item that was displayed, or awarding one point if a threshold portion of the content item has been displayed and zero points if less than the threshold portion of the content item has been displayed. For example, the area displayed detection module 401 may award one point if at least 75% of the pixels of the content item's card is displayed, and zero points if less than 75% of the pixels of the content item's card is displayed. Other examples may set the threshold higher or lower or may use another measure related to the area of the content item that was displayed, such as the percentage of the user's screen filled with the content item, the percentage of the length of the card that was displayed, or the like.

The time displayed detection module 402 detects the length of time that a content item has been displayed to the user. Generally, the amount of time that the content item has been displayed is indicative of whether the scoring module should determine that the user has seen the content item. In one embodiment, as the length of time that the content item has been displayed increases, so does the likelihood that the user saw the content item. Various scoring schemes may be used. For example, the elapsed time may be measured from when at least the threshold percentage of pixels of the content item's card have been displayed to when fewer than the threshold percentage of pixels of the content item's card are still displayed. Alternatively, the elapsed time may be measured during which the entire screen of the client device 120 is covered by the content card. The number of points awarded in the scoring scheme may correspond to the length of time that has been measured. In one example, if such elapsed times are at least 0.4 seconds, a point is awarded. Other examples may set the threshold elapsed time higher or lower or may use another measure related to the length of time that a content item was displayed.

The score aggregator 403 converts the output from the detection modules 401 and 402, and optionally from additional detection modules (not shown) into an aggregate score that indicates whether the user is determined to have seen the content item. The score aggregator 403 may simply add the respective scores from each detection module and compare the aggregate to a threshold score. If the aggregate score exceeds the threshold score, the user is determined to have seen the content item. Alternatively, depending on the scoring schemes used by the detection modules 401 and 402, the score aggregation 403 may use a weighted average or any other method of combining the scores from the detection modules 401 and 402.

The filter 404 optionally filters out certain instances of determinations that a user has seen a content item, for example, to avoid inflating the number of content items that have been determined to be seen in a short period of time. In some implementations, it may be beneficial to avoid double counting a content item as seen when a user scrolls past an article twice in rapid succession. For example, the filter 404 may remove instances where the same article has already been seen within the last minute or other short threshold measure of time. Another example filter 404 may remove one instance of the content item being seen where a threshold number of other content items have not been seen between two instances of the same content item being seen. An even stricter filter 404 may remove instances where a content item has already been seen within the same contiguous session of a user's interaction with the client application 121 (e.g., without leaving the client application 121, etc.).

Provided that the determination of a content item being seen passes any filter 404, the scoring module 304 may increment a count of the number of seen content items and mark the content item as seen in the content cache 301. Optionally, a report of the seen content items may also be communicated by the server interaction module 122 to the server system 110 so that the server system 110 has access to the data describing the user's usage of the client application 121. By receiving reports of such metrics, the server system 110 may analyze the data across client devices 120 to learn patterns in usage among users. Additionally or alternatively, the information presentation module 123 may alter the appearance of content items determined to have been seen by a user as compared to those that have not yet been determined to have been seen by the user, or in some cases the information presentation module 123 may remove seen content items from those subsequently presented to the user.

FIG. 5 is a flowchart illustrating a method of determining if a content item has been seen according to an embodiment. This example method is described from the perspective of an information presentation module 123 of the client application performing the method, but in some variations, other modules may perform the steps of the method. In some implementations, the steps are performed in an order other than the order presented in FIG. 5, and in other implementations, additional or alternative steps may be performed.

In step 501, the area of the content item that has been displayed is detected. For example, the area displayed detection module 401 detects the amount of area of a content item that has been displayed to the user by the user interface module 303. Based on the detected area, a score may be awarded that indicates the likelihood that the displayed content item was seen by the user. Generally, a higher proportion of the content item's area that has been displayed corresponds to a higher likelihood that the content item was seen by the user.

In step 502, the length of time that the content item has been displayed is detected. For example, the time displayed detection module 402 detects the length of time that a content item has been displayed to the user by the user interface module 303. Based on the length of time, a score may be awarded that indicates the likelihood that the displayed content item was seen by the user. Generally, a longer time that the content item has been displayed corresponds to a higher likelihood that the content item was seen by the user.

In step 503, an aggregate score for a content item is determined based at least in part on the detected area and the detected length of time. For example, the score aggregator 403 of the scoring module 304 of the information presentation module 123 of the client application 121 may determine the aggregate score from the combination of the scores awarded for the amount of area of the content item that has been displayed and the length of time that the content item has been displayed.

In step 504, responsive to the aggregate score exceeding a threshold, the user is determined to have seen the content item. For example, the score aggregator 403 may compare the aggregate score against a threshold score. If the aggregate score does not exceed the threshold, then the user is deemed not to have seen the content item. Conversely, if the aggregate score exceeds the threshold, one or more filters 404 may be applied as described above to filter out certain instances. Then, provided that the determination of a content item being seen survives any filters 404 applied, the scoring module 304 may increment a count of the number of seen content items, mark the content item as seen in the content cache 301, and optionally report how many and/or which content items have been seen to the server system 110.

FIG. 6A illustrates an example of a user interface 660 of a client application 121 of a client device 120 displaying the majority of a first content card 661 and a small portion of a second content card 662, according to an embodiment. In this example, in this state, more than 75% of the pixels of the first content card 661 are displayed, whereas less than 75% of the pixels of the second content card 662 are displayed. Thus, if the threshold is set at 75% of the pixels of the content card, the area displayed detection module 401 may award a point to the content item of the first content card 661 and not yet award a point to the content item of the second content card 662. FIG. 6B illustrates an example of the user interface 660 shown in FIG. 6A after a user has scrolled down to reveal a larger portion of the second content card 662, according to an embodiment. In this example, in this state, more than 75% of the pixels of the second content card 662 have been displayed. Thus, the area displayed detection module 4401 may consequently award a point to the content item of the second content card 662. These points may be combined with scores from the time displayed detection module 402 and optionally other measurement modules by a score aggregator 403 to conclude the determination as to whether the user has seen each content item.

Additional Configuration Considerations

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for automated dictionary generation. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein.

What is claimed is:

1. A computer-implemented method of determining whether a user has seen a content item, the method comprising:
detecting an area of the content item that has been displayed;
detecting a length of time that the content item has been displayed;
determining an aggregate score for the content item based at least in part on the detected area and the detected length of time; and
responsive to the aggregate score exceeding a threshold, determining the content item has been seen by the user.

2. The method of claim 1, wherein detecting an area of the content item that has been displayed comprises detecting a percentage of pixels of a card containing the content item that has been displayed.

3. The method of claim 1, wherein detecting a length of time that the content item has been displayed comprises detecting an elapsed time from when at least a threshold percentage of pixels of a card containing the content item has been displayed to when fewer than a threshold percentage of pixels of a card containing the content item are still displayed.

4. The method of claim 1, wherein detecting a length of time that the content item has been displayed comprises detecting an elapsed time during which the user's screen is covered by a card containing the content item.

5. The method of claim 1, wherein determining an aggregate score for the content item based at least in part on the detected area and the detected length of time comprises combining a first score based on the detected area with a second score based on the detected length of time to calculate the aggregate score.

6. The method of claim 1, further comprising:
responsive to the same content item not having been determined to be previously seen within a short period of time, incrementing a count of seen content items.

7. A non-transitory computer-readable storage medium storing executable computer program instructions for determining whether a user has seen a content item, the instructions executable to perform steps comprising:
detecting an area of the content item that has been displayed;
detecting a length of time that the content item has been displayed;
determining an aggregate score for the content item based at least in part on the detected area and the detected length of time; and
responsive to the aggregate score exceeding a threshold, determining the content item has been seen by the user.

8. The medium of claim 7, wherein detecting an area of the content item that has been displayed comprises detecting a percentage of pixels of a card containing the content item that has been displayed.

9. The medium of claim 7, wherein detecting a length of time that the content item has been displayed comprises detecting an elapsed time from when at least a threshold percentage of pixels of a card containing the content item has been displayed to when fewer than a threshold percentage of pixels of a card containing the content item are still displayed.

10. The medium of claim 7, wherein detecting a length of time that the content item has been displayed comprises detecting an elapsed time during which the user's screen is covered by a card containing the content item.

11. The medium of claim 7, wherein determining an aggregate score for the content item based at least in part on the detected area and the detected length of time comprises combining a first score based on the detected area with a second score based on the detected length of time to calculate the aggregate score.

12. The medium of claim 7, the instructions executable to further perform:
responsive to the same content item not having been determined to be previously seen within a short period of time, incrementing a count of seen content items.

13. A system for determining whether a user has seen a content item, the system comprising:
a processor configured to execute modules; and
a memory storing the modules, the modules comprising:
an area displayed detection module configured to detect an area of the content item that has been displayed;
a time displayed detection module configured to detect a length of time that the content item has been displayed; and
a score aggregator configured to determine an aggregate score for the content item based at least in part on the detected area and the detected length of time, wherein responsive to the aggregate score exceeding a threshold, the content item is determined to have been seen by the user.

14. The system of claim 13, wherein the area displayed detection module is further configured to detect a percentage of pixels of a card containing the content item that has been displayed.

15. The system of claim 13, wherein the time displayed detection module is further configured to detect an elapsed time from when at least a threshold percentage of pixels of a card containing the content item has been displayed to when fewer than a threshold percentage of pixels of a card containing the content item are still displayed.

16. The system of claim 13, wherein the time displayed detection module is further configured to detect an elapsed time during which the user's screen is covered by a card containing the content item.

17. The system of claim 13, wherein the score aggregator is further configured to combine a first score based on the detected area with a second score based on the detected length of time to calculate the aggregate score.

18. The system of claim 13, the modules further comprising:
a filter configured to remove an instance of the content item being determined to be seen by the user responsive to the same content item having already been determined to have been seen within a short threshold measure of time.
